(19) United States
(12) Patent Application Publication
(10) Pub. No.: US 2005/0180815 A1
(43) Pub. Date: Aug. 18, 2005

(54) Connectors for connecting conservatory structural elements

(76) Inventor: Cliff Gordon, Armagh (GB)

Correspondence Address: ADAMS EVANS P.A., 2180 TWO WACHOVIA CENTER, CHARLOTTE, NC, 28282, US

(21) Appl. No.: 10/505,808

(22) PCT Filed: Feb. 27, 2003
(86) PCT No.: PCT/GB03/00805

(30) Foreign Application Priority Data
Mar. 1, 2002 (GB) 0204883.3

(51) Int. Cl. F16D 1/00

(52) U.S. Cl. 403/348

(57) ABSTRACT

A connector (30) for connecting conservatory structural elements, the connector comprising a first connector part (32) comprising a male connector (36) joined to a female connector (38), and a second connector part (34) comprising a male connector (36) joined to a femal connector (38), in which a male connector of a first connector part is rotatably engageable in a female connector of the second connector. Also disclosed is a method of assembly of at least part of a conservatory structure (52, 54) and a conservatory structure (or part thereof) using such a connector (30) is also disclosed.

### FIELD OF THE INVENTION

The present invention relates to connectors for connecting conservatory structural elements, especially, but not exclusively for connecting ringbeams to roof beams. The invention extends to methods of assembly of at least part of a conservatory structure and to at least part of such conservatory structures using such connectors.

### BACKGROUND TO THE INVENTION

At a ringbeam, the vertical wall of a conservatory is connected to a roof beam running to a ridge or crown. A connection needs to be provided between a first ringbeam and a second ringbeam, but the ringbeams may need to extend from one another at a variety of angles. Further a versatile connector is desirable for connecting other structural elements of a conservatory structure.

It is known for such a purpose to provide a connector of the type shown in FIGS. 1 and 2 of the drawings that follow. In FIGS. 1 and 2 there is shown a first connector part 2 comprising a first male connector 4 and a second male connector 6 at either end of a connector body 8. Each male connector 4, 6 is joined to the connector body 8 by an angled portion 10, 12 respectively. The connector body 8 incorporates screw ports 14, 16. A second connector part 18 comprises a female connector 20, from which extends a connector body 22 incorporating screw ports 24, 26.

Male connector parts 4, 6 slidingly fit in the female connector part 20 and are capable of rotating therein.

Angled portion 10 is configured relative to first male connector 4 whereby, as shown in FIG. 1, the first connector part 2 can be rotated relative to the second connector 18 between the angles of 0° and 45°. Angled portion 12 is configured relative to second male connector 6 whereby, as shown in FIG. 2, the first connector part 2 can be rotated relative to the second connector part 18 between the angles of 45° and 90°. Thus to achieve the different angle ranges, either the first male connector 4 or the second male connector 6 is inserted in female connector 20.

To secure the first and second connector parts 2, 18 relative to the structural elements of a conservatory, screws or bolts are driven through the relevant structural part to engage in the screw ports 14, 16, 24 and/or 26.

It is an aim of preferred embodiments of the present invention to obviate or overcome a disadvantage of the prior art, whether referred to herein or otherwise.

### SUMMARY OF THE INVENTION

According to the present invention in a first aspect, there is provided a connector for connecting conservatory structural elements, the connector comprising a first connector part comprising a male connector joined to a female connector, and a second connector part comprising a male connector joined to a female connector, in which a male connector of a first connector part is rotatably engageable in a female connector of the second connector.

Suitably, inversion of one of the connector parts relative to the other provides a different range of angular relationships between the first and second connector parts.

Suitably, the first connector part is asymmetrically rotatable relative to the second connector part.

Thus by inversion of a connector part relative to the other, a first and second range of relative rotational movement can be achieved.

Preferably the male connector of the first connector part is substantially similar to the male connector of the second connector part. Preferably, the female connector of the first connector part is substantially similar to the female connector of the second connector part.

Preferably, the first connector part is substantially similar to the second connector part. Thus the same extrusion can be used for the first and second connector parts providing a significant cost saving and a reduced requirement for stocks.

Suitably, the male connector of a connector part is joined to the female connector of a connector part by a body portion. Suitably, at least one screw port is provided in the body portion.

Suitably, the male and/or female connector of a connector part is joined to the body portion by an angled section. The section is angled by not being a parallel extension of the body portion.

Suitably, a female connector comprises an offset open portion.

According to the present invention in a second aspect, there is provided a method of assembly of at least part of a conservatory structure, which method comprises the step of using a connector according to the first aspect of the present invention to connect at least two structural elements thereof.

According to the present invention in a third aspect, there is provided a conservatory structure or part thereof comprising a first structural element, a second structural element and a connector according to the first aspect of the present invention connecting the first structural element to the second structural element.

### BRIEF DESCRIPTION OF THE DRAWINGS

The present invention will now be described, by way of example only, with reference to the drawings that follow; in which:

FIG. 1 is a cross-sectional elevation of a prior art connector in a first configuration.

FIG. 2 is a cross-sectional elevation of the prior art connector of FIG. 1 in a second configuration.

FIG. 3 is a cross sectional elevation of a connector according to an embodiment of the present invention in a first configuration.

FIG. 4 is a cross-sectional elevation of the first connector part shown in FIG. 3.

FIG. 5 is across-sectional elevation of the connector shown in FIG. 3, in a second configuration.

FIGS. 6-8 are perspective illustrations of connectors according to the present invention in use to connect first and second ring beams.

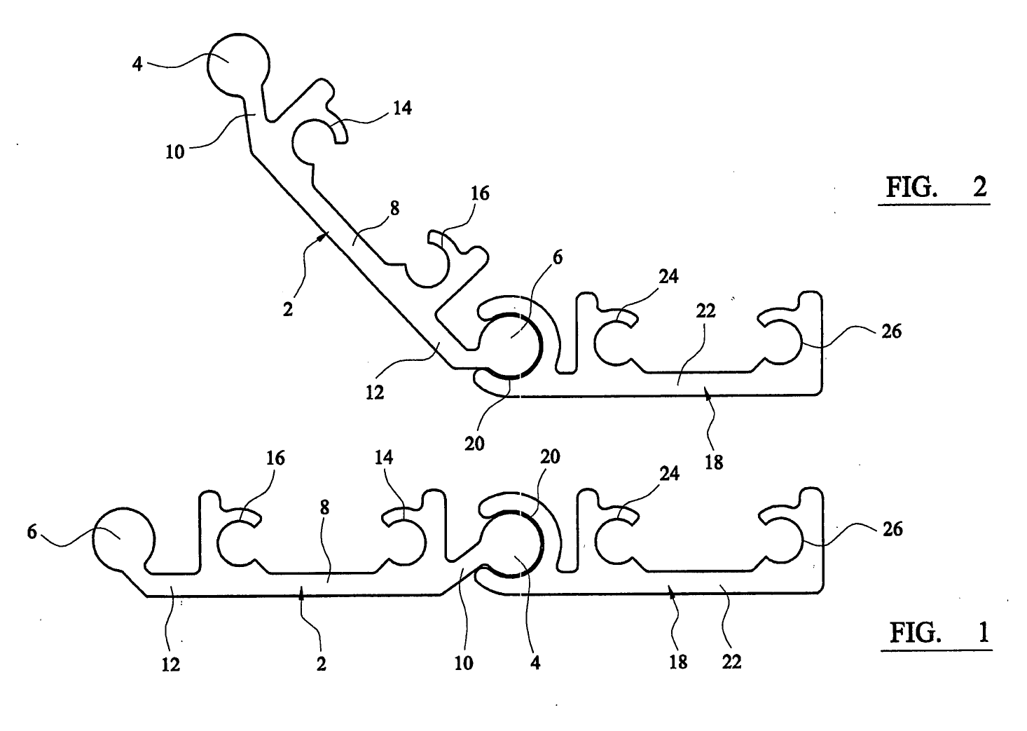

### DESCRIPTION OF THE PREFERRED EMBODIMENT

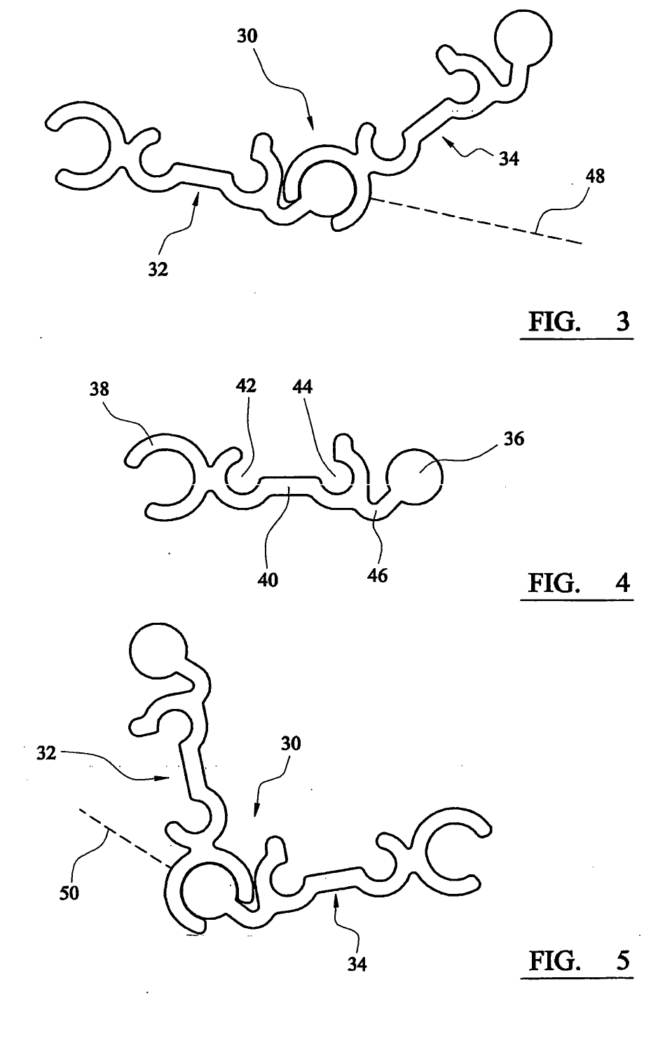

Referring to FIG. 3 of the drawings that follow, there is shown a connector 30 comprising a first connector part 32 and a second connector part 34. The first and second connector parts 32, 34 are formed from aluminium extrusions.

Referring to FIG. 4 of the drawings that follow, the first connector part 32 can be seen to comprise a male connector 36 of generally circular cross-section and a female connector 38 forming a C-shaped limb. A body portion 40 extends between male connector 36 and female connector 38. Body portion 40 carries two screw ports 42, 44. The C-shaped limb of female connector 38 is offset, i.e. non-symmetrical with respect to the plane of the body portion 40, and male connector 36 is attached to body portion 40 by an angled (with respect to the plane of body portion 40) section 46.

The second connector part 34 is substantially similar to first connector part 32 and generally will be formed from the same extrusion cut to length.

Referring to the connector configuration of FIG. 3, first connector 32 is slidingly engaged with second connector 34. First connector 32 is capable of pivotal rotational movement relative to second connector 34 through the angles of 0° to 45°, the latter being shown (the 0° angle is shown by the dashed line 48 in FIG. 3).

By inverting the first connector part 32, as shown in FIG. 5 of the drawings that follow, an angle range of from 45° (shown by dashed line 50) to 90°, as shown in the FIG. 5, can be achieved.

By having the C-shaped limb of the female connector 38 offset and the angle section 46 at an angle, the first and second connector parts 32, 34 are asymmetrically rotatable in that when one connector part is rotated relative to the other the moved part does not rotate to a symmetrical position relative to the stationary part.

The connector is suitable for use with conservatory structures, especially ring beams.

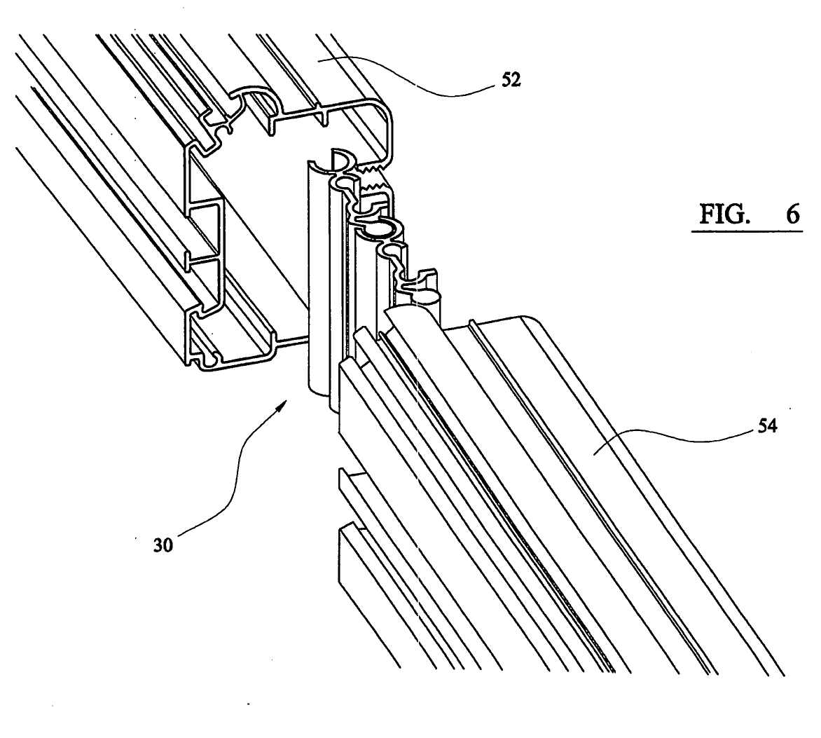

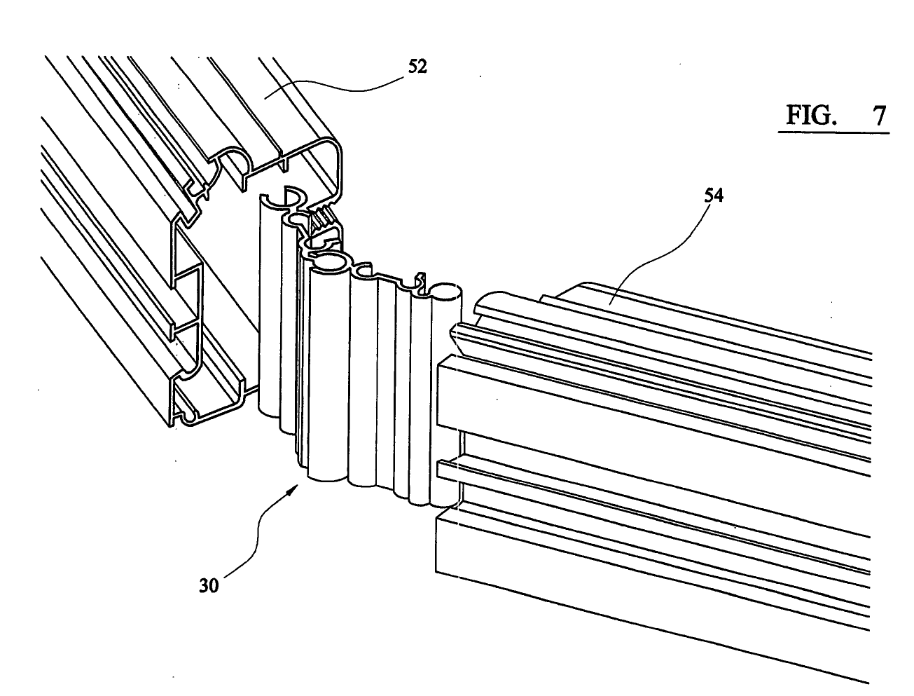

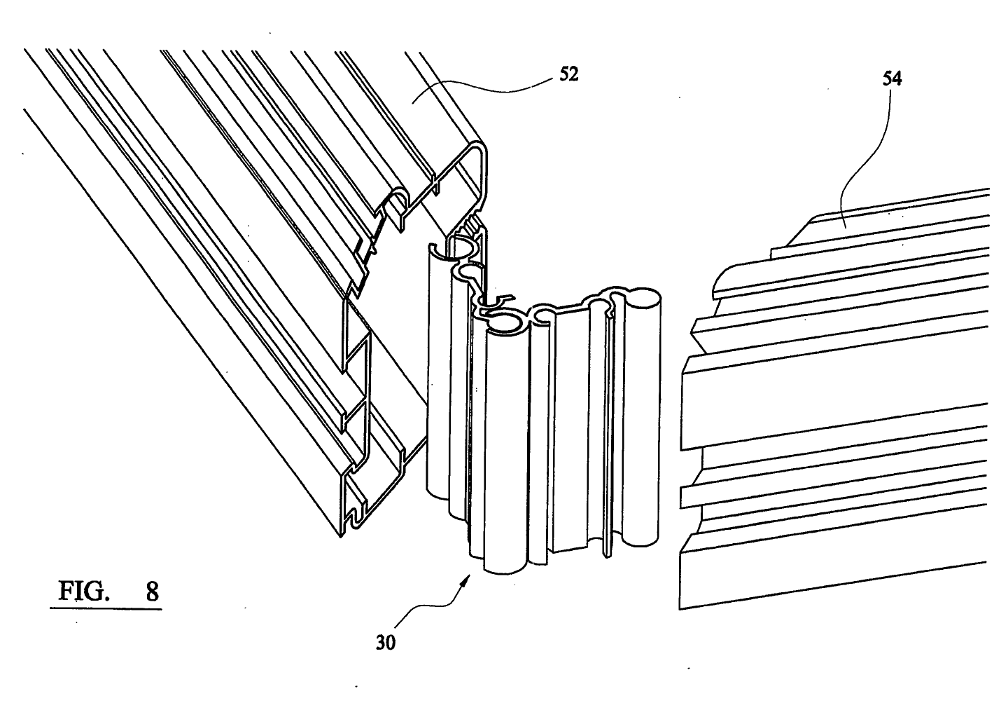

Referring to FIGS. 6-8 of the drawings that follow a connector 30 is shown in a range of configurations for connecting a first ringbeam 52 to a second ringbeam 54, which forms a part of a conservatory structure. Screws or bolts (not shown) are driven through the first and second ringbeams into respective screw ports of the connector to secure the connector in place relative to the beams. The connector 30 can be used to connect other structural elements of a conservatory structure, but it is particularly useful for the connection of a first ringbeam to a second ringbeam because of the angular flexibility it provides.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1-12. (canceled)

13. A connector for connecting conservatory structural elements, the connector comprising first and second components for being mounted on respective adjacent structural elements of a conservatory, the first and second components each comprising a male connector element joined to a female connector element and wherein a male connector element of the first component is rotatably engageable in a female connector element of the second component.

14. A connector for connecting conservatory structural elements according to claim 13, in which inversion of one of the first and second components relative to the other provides a different range of angular relationships between the first and second components.

15. A connector for connecting conservatory structural elements according to claim 13, in which the first component is asymmetrically rotatable relative to the second component.

16. A connector for connecting conservatory structural elements according to claim 13, in which the male connector element of the first component is substantially similar to the male connector element of the second component.

17. A connector for connecting conservatory structural elements according to claim 13, in which the female connector element of the first component is substantially similar to the female connector element of the second component.

18. A connector for connecting conservatory structural elements according to claim 13, in which the first component is substantially similar to the second component.

19. A connector for connecting conservatory structural elements according to claim 13, in which the male connector element of a component is joined to the female connector of a component by a body portion.

20. A connector for joining conservatory structural elements according to claim 19, in which at least one screw port is provided in the body portion.

21. A connector for connecting conservatory structural elements according to claim 19, in which the male and/or female connector element of a component is joined to the body portion by an angled section.

22. A connector for connecting conservatory structural elements according to claim 13, in which a female connector element comprises an offset open portion.

23. A method of assembly of at least part of a conservatory structure, which method comprises the step of using a connector according to claim 13 to connect at least two structural elements thereof.

24. A conservatory structure or part thereof comprising a first structural element, a second structural element and a connector connecting the first structural element to the second structural element, in which the connector is according to claim 13.
